(19) United States
(12) Patent Application Publication
(10) Pub. No.: US 2016/0070413 A1
(43) Pub. Date: Mar. 10, 2016

(54) Method and System for Resolving Multiple Proximate Touches

(71) Applicant: 3M INNOVATIVE PROPERTIES COMPANY, Saint Paul, MN (US)

(72) Inventor: Bernard O. Geaghan, Salem, NH (US)

(21) Appl. No.: 14/782,636

(22) PCT Filed: Apr. 1, 2014
(86) PCT No.: PCT/US14/32443

§ 371 Date: Oct. 6, 2015

Related U.S. Application Data
(60) Provisional application No. 61/809,549, filed on Apr. 8, 2013.

(51) Int. Cl. G06F 3/041; G06F 3/0488; G06F 3/044

(52) U.S. Cl. CPC G06F 3/0418; G06F 3/044; G06F 3/04883; G06F 2203/04104; G06F 2203/04808

(57) ABSTRACT

Multiple close, temporally overlapping touches are resolved on a matrix-type touch sensitive panel by generating touch profiles based on the multiple touches, and comparing the touch profiles to a library pre-defined profiles, using correlative techniques.

### BACKGROUND

Resolving multiple touches in close proximity is required for accurate touch location and for identification of multi-touch gestures. Closer spacing of electrodes improves multi-touch resolution but this is costly, especially for large sensors. Improved methods of this invention can also enhance multi-touch resolution.

### SUMMARY

Methods and systems for receiving touch-related measurement data and therefrom forming a measured profile, then fitting the measured profile to a set of pre-determined profiles to determine which one of the pre-determined profiles adequately fits the measured profiles. The pre-determined profiles can be associated with many types of touch events that may be difficult to resolve using conventional techniques. For example, one of the pre-determined profiles may be associated with two, three, four, etc. fingers touching a touch surface in very close proximity. The fitted profile may be used to determine the type of touch event occurring, and/or the locations associated with multiple, closely located pointing objects (finger tips, for example).

### SUMMARY OF DRAWINGS

FIG. 1 is a simplified schematic of a touch sensitive device;

FIG. 2 is a simplified schematic of a touch sensitive device;

FIG. 3a is graph showing two profiles of fingertip touch signals on a matrix-type touch screen;

FIG. 3b is a graph showing signal responses associated with two touches in close proximity;

FIG. 4 is a graph showing an array of data values associated with touches upon a matrix-type touch screen;

FIG. 5a is a table showing values associated with vectors shown in the graph of FIG. 4;

FIG. 5b is a table showing values associated with vectors shown in the graph of FIG. 4;

FIG. 6a is a table showing an array of values for a four-touch cluster;

FIG. 6b is a table showing an example of inter-value interpolation associated with a method described herein;

FIG. 7a is a graph showing data associated with results of applying a method described herein;

FIG. 7b is a graph showing values of a width vector that intersects a peak associated with the graph of FIG. 7a;

FIG. 8a is a table showing an array of values measured from a row of five touches;

FIG. 8b is a table showing a ridge line vector in linear form;

FIG. 8c is a table showing values associated with correlated values;

FIG. 8d is a table showing values associated with correlated values;

FIG. 9 is a graph showing ridge values and correlated values;

FIG. 10a is a graph showing data measured on a mutual capacitance type touch screen;

FIG. 11a is a graph showing simulated data associated with touch screen response;

FIG. 11b is a graph showing a curve associated with a capacitive coupling profile;

FIG. 11c is a graph showing curves that simulate capacitive coupling profiles of pairs of touches;

FIG. 12a is a graph showing curves associated with a capacitive coupling profile;

FIG. 12b is a graph showing curves associated with a capacitive coupling profile;

FIG. 13a is a graph showing curves associated with a capacitive coupling profile;

FIG. 13b is a graph showing curves associated with a capacitive coupling profile;

FIG. 13c is a graph showing curves associated with a capacitive coupling profile;

FIG. 13d is a graph showing curves associated with a capacitive coupling profile;

FIG. 13e is a graph showing curves associated with a capacitive coupling profile;

FIG. 13f is a graph showing curves associated with a capacitive coupling profile;

FIG. 13g is a graph showing curves associated with a capacitive coupling profile;

FIG. 14 is a flowchart showing a process associated with using pre-determined profiles to sense touch events;

FIG. 15a is a graph showing dot-dashed Gaussian curves representing values associated with capacitive coupling for a touch event;

FIG. 15b is a graph showing dot-dashed Gaussian curves representing values associated with capacitive coupling for a touch event;

FIG. 15c is a graph showing dot-dashed Gaussian curves representing values associated with capacitive coupling for a touch event;

FIG. 16a is a table showing profiles and locations calculations associated with two touches;

FIG. 16b is a table showing profiles and locations calculations associated with two touches; and,

FIG. 16c is a table showing profiles and locations calculations associated with two touches.

In the figures, like reference numerals designate like elements.

### DETAILED DESCRIPTION

The invention is an enhancement to methods of resolving multiple touches and interpolation of touched locations in a capacitive touch system comprising an array of electrodes and control circuits. Electrode capacitance (mutual capacitance and/or self capacitance) is modified by presence of one or more touch(s), and each touch yields a profile of measurement values on proximate electrodes. The enhancement includes methods of identifying multiple touches using aspect ratios and/or correlation, and resolving single or multiple temporally overlapping touches by correlation with known touch signal profiles.

Known touch signal profiles may be generated mathematically based on sensor parameters, or they may be measured during a calibration process. Separate profiles may be used in different areas of a touch screen, e.g. special edge profiles may be used to interpolate or extrapolate touch locations near edges. Separate profiles may be generated to represent a single touch, and two or more very-near touches. Interpolation may be performed between measured values or between correlation coefficients.

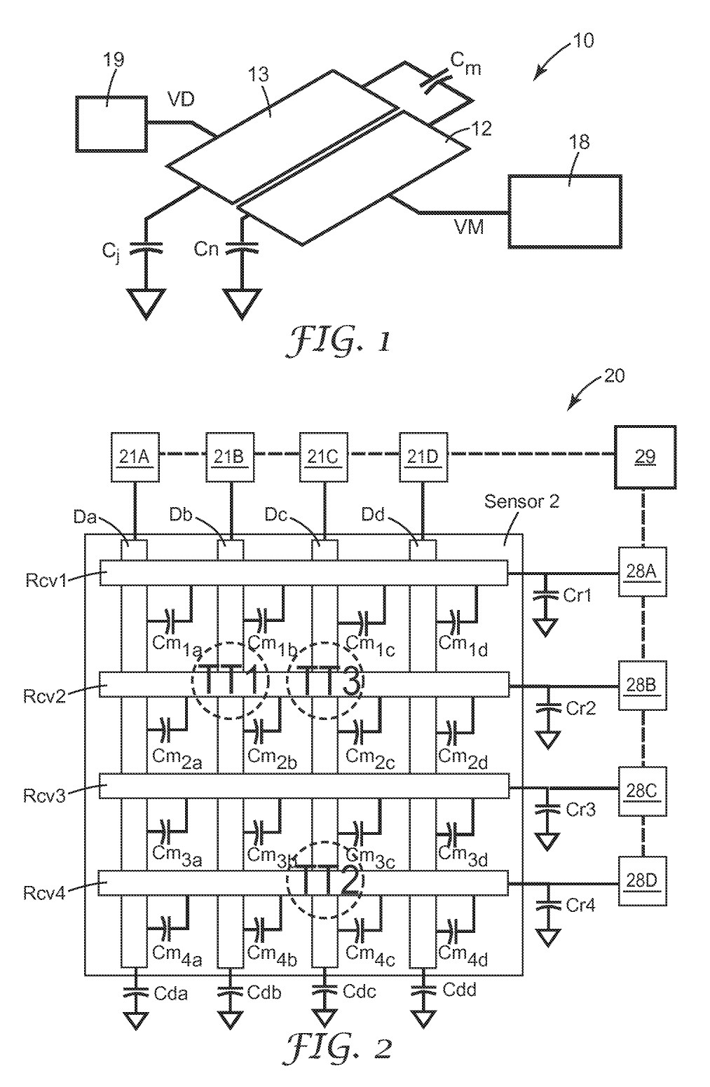

FIG. 1 shows a simplified schematic of a device 10 for measuring mutual capacitance Cm between two electrodes 12 and 13. Measurement circuitry 18 and drive circuitry 19 are connected to receiver electrode 12 and driven electrode 13 and are used to measure mutual capacitance Cm. Devices for measuring capacitance can take the form of capacitive input (for example, touch) devices such as buttons and switches, linear sliders, and matrix touch panels, as well as sensors for detecting the presence or amount of a substance positioned proximate the electrodes, or a digitizer for capacitive detection of a stylus. In each of these situations, at least one unknown mutual capacitance (denoted Cm herein) results from coupling between electrodes, and second and third unknown capacitances (denoted Cd and Cr herein) results from coupling between driven electrode and ground, and receive electrode and ground. Cm, Cd and Cr change when an object or substance comes into proximity with the electric field generated when AC voltages are applied to at least one of the electrodes. This change may be used as a basis for identifying a touch or the presence of an object or substance.

FIG. 2 shows a simplified schematic of a device 20 for measuring locations of a touching object (for example, touches to points TT1, TT2, and TT3). Driven electrodes Da-Dd have capacitances to ground Cda-Cdd respectively and receive electrodes Rcv1-Rcv4 have capacitances to ground Cr1-Cr4 respectively. Capacitances between driven electrodes and receive electrodes have mutual capacitances Cm1a-Cm4d. Capacitances Cda-Cdd, Cr1-Cr4, and Cm1a-Cm4d change when a touching object is in proximity. In a typical matrix mutual capacitance sensor, mutual capacitances Cm are approximately equal, and equal Cm's are assumed unless otherwise stated. Capacitances to ground Cr and Cd are typically larger in magnitude than Cm. Controller 29 includes electronics that comprise measurement circuitry and drive circuitry, to measure changes in mutual capacitance levels occurring on device 20.

Touch locations may be resolved (located) by measuring changes in capacitances Cm and/or changes in capacitance to ground (e.g. Cr and/or Cd) on adjacent electrodes to form a touch profile, which is then compared with a pre-defined set of other profiles that are indicative of, for example, one touch, or two touches (or more) located in very close proximity. This comparison is typically a correlation function of some sort. Based on the comparison, for example, the touch profile may be correlated with the pre-determined profile that is associated with two close, temporally overlapping touches. Thus multiple touches may be deciphered, and locations associated therewith reported to a computer by controller 29. A correlation approach to locating one or more temporally overlapping touch events may, in some embodiments, be better able to resolve two or more temporally overlapping touches that are so close together that neither produces an individually identifiable signal, relative to using traditional interpolation and threshold-based touch resolving methods.

Mutual capacitances Cm1a-Cm4d and capacitances Cda-Cdd and Cr1-Cr4 can be measured by the methods known in the art. For example, systems and methods for measuring Cm, Cd or Cr, and also for measuring useful parameters of Cm, Cd and Cr including ratios of Cm and Cr are disclosed in, for example, US Patent application publications nos. US20080142281, US20100073323, and US20110163766.

Receive circuits 28a-d measure signals on receiver electrodes Rcv1-Rcv4 respectively, under the control of controller 29. Drive circuits 21a-d apply signals to electrodes Da, Db, Dc, and Dd respectively under the control of controller 29. In some embodiments described herein, some of circuits 21-28 may be switched between drive and receive functions, so in one mode Da-Dd are driven while Rcv1-Rcv4 receive, then in another mode Rcv1-Rcv4 are driven while Da-Dd receive signals. Though drive and receive circuits are shown individually, they may also be configured as part of a multiplexer configuration, particularly on the drive side.

Touches TT1, TT2, and TT3 in simplified exemplary system 20 are shown as directly on electrode intersections, affecting only one touch-proximate electrode. This is for illustration purposes only. With typical matrix touch screens, a single touch will affect capacitance and signals on two or more adjacent electrodes, and interpolation methods are used to resolve touch locations with finer resolution than the spacing of electrodes.

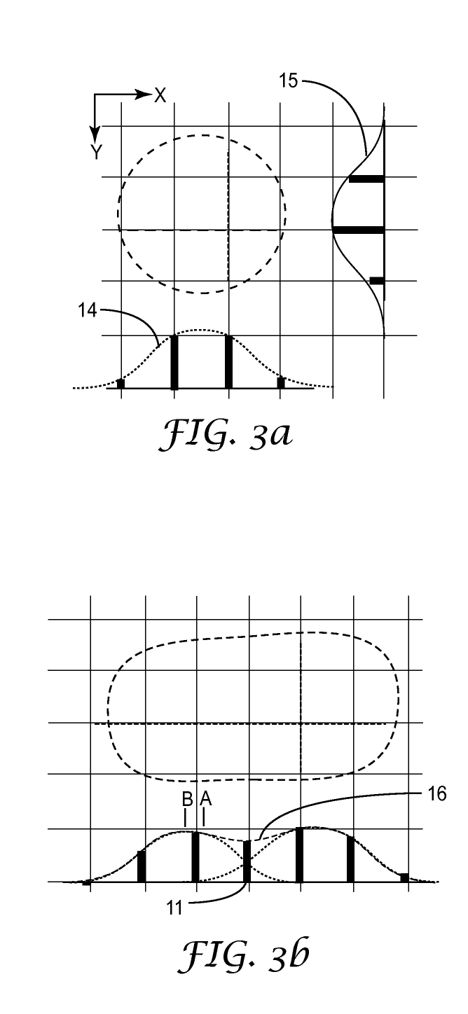

FIG. 3a shows two profiles of fingertip touch signals upon a matrix-type mutual capacitive touch screen such as that shown in FIG. 2. Lines in the background matrix represent X- and Y-electrodes in a touch screen. In FIG. 3a, a single touch on a matrix of electrodes 12 results in measured mutual capacitance value changes at electrode cross-over areas (or nodes), in reference to FIG. 2, Cm. FIG. 3a shows a profile 14 of four values measured in the X dimension and a profile 15 of three values measured in the Y dimension. Both profiles have approximately a Gaussian shaped profile.

FIG. 3b shows two touches in proximity. They have the same profile in the Y-axis as the single touch in represented in FIG. 3a (profile not shown in FIG. 3b), but the X-axis profile 16 has a complex shape because signals of two touches are merged. It may be difficult to discriminate whether there is one touch or two. Methods described herein are used to discriminate multiple touches from single touches, and to resolve the locations of multiple proximate touches. Multi-touch discrimination may be accomplished using image recognition on a two dimensional array of data, or simplified methods described herein may be used to reduce the problem to analysis of a vector array in one dimension. Included are methods of identifying a vector array of touch values by calculating a Ridge line within a cluster of touch data values; correlating arrays of touch values with waveforms to identify touch locations; apportioning intermediate values (e.g. value 11, FIG. 3b) between touch centroids, and calculating touch locations. Using these methods, a complex profile 16 may be resolved into multiple single-touch profiles such as represented by the overlapping Gaussian curves shown along the X-axis in FIG. 3b.

The guiding concept of this disclosure is that a complex array of measured touch values, (such as the seven values under profile 16) can be resolved by correlation into two or more sub-arrays, and in the case of finger or stylus touches, the sub-arrays will have a consistent shape, for example that of a Gaussian distribution. This method of resolving a complex array of values into component shapes is similar to the process in a Fast Fourier Transform, (FFT) where a complex waveshape is resolved into multiple sine waves of various wavelengths, phases and relative magnitudes, using correlation functions. Methods of the present disclosure also correlate waveforms of various lengths, and the position of the waveforms is shifted to maximize a correlation function.

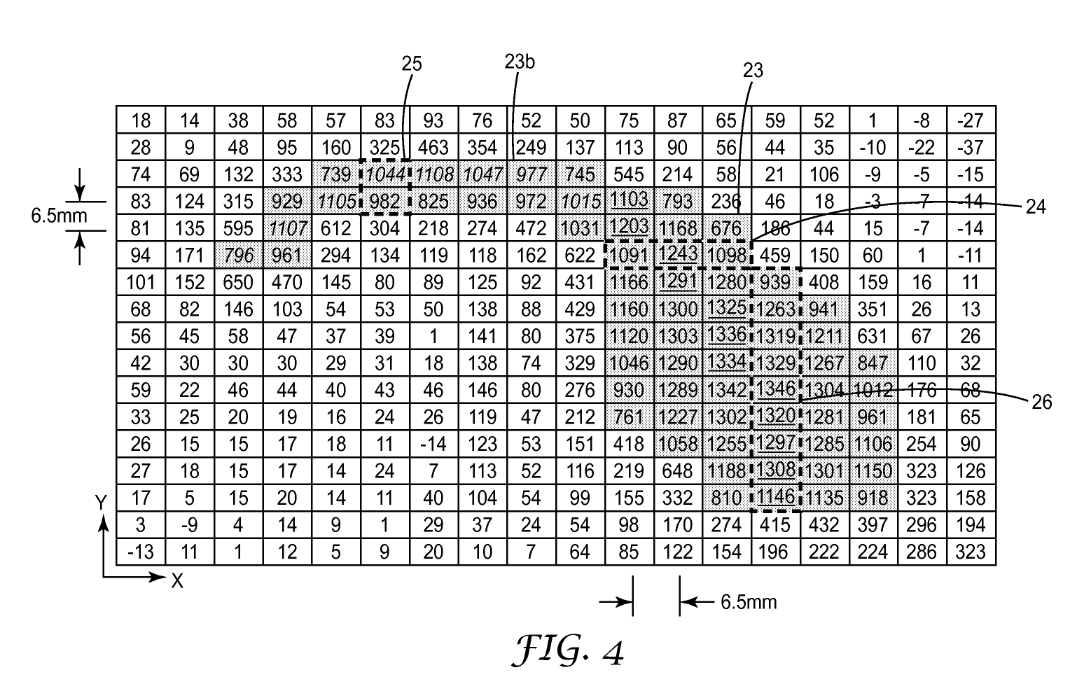

FIG. 4 shows an array of data values measured from a touch sensor comprising parallel horizontal electrodes and parallel vertical electrodes. The distance between electrodes is 6.5 mm in both X and Y dimensions. The data measurements are the result of a contact by the edge of a hand and finger. Each value represents a change in mutual capacitance at a node where a horizontal electrode and a vertical electrode cross over. Highlighted values exceed a touch threshold value (which for purposes of the data shown in FIG. 4 is chosen to be 673, which is ½ the maximum value of a datum in FIG. 4). Other touch threshold values may be used, but half the maximum is often effective in indicating important signal values while minimizing the number of calculations required, and this level is used for examples herein.

The cluster 23 of contiguous above-threshold values is shown as highlighted values FIG. 4. Within the cluster, the highest value is identified as 1346. Starting with the highest value, a subset of “ridge line” values is identified, the ridge line comprising a vector that approximately follows the largest values in a cluster. In the examples used herein, unless otherwise noted, a vector is a 1-wide by N-long string of values measured on adjacent nodes, all of which are greater than the threshold (>Th). The ridge line may be identified by any suitable algorithm; one possible approach is as follows:

1.1. Select the highest Value (V1) in an area to be analyzed, (e.g. initially, the whole touch area).
1.2. Calculate a touch Threshold value, (Th), [e.g. Th=(V1)/2 and V1>(noise threshold)]
1.3. Store the selected value=1st ridge value.
1.4. Find the next value (Vnew) in the ridge.
1.4.1. Calculate the Vector sum of the X vector and Y vector that intersect the selected value.
   X vector is the horizontal set of contiguous values that are greater than Th.
   Y vector is the vertical set of contiguous values that are greater than Th.
1.4.2. Select the Width vector, (smaller of X vector or Y vector).
1.4.3. IF: either value adjacent to the selected value & in the Width vector is larger than the selected value, THEN;
   1.4.3.1. Store the adjacent value as the next value in the Ridge=Vnew, then GO TO 1.4.1;
   1.4.3.2. ELSE: Select Vnew=highest adjacent value in one of the 2 Width vectors adjacent (& parallel) to the current Width vector, excluding previously selected Values.
      1.4.3.2.1. Highest adjacent includes diagonals, so Vnew is selected from 3 values.
1.4.4. IF: Vnew>Th, Store it as the next value in the Ridge=Vnew, then GO TO 1.4.1;
1.4.5. ELSE: Vnew<Th, end of the ridge has been reached. Return to V1 & select 2nd highest adjacent Value (i.e. from V1, follow the ridge in the opposite direction);
   1.5. If the Width vector changes from the X dimension to Y or vice versa, the ridge Line may be segmented at that point into separate ridge segments that are handled separately in subsequent calculations. After calculations are complete, separate ridge segments may be re-combined and reported as a single touch, or they may be reported as separate touches.

The data shown in FIG. 4 has two ridge segments. One has underlined values (Y vector); the other has italicized values (X vector). If a higher accuracy ridge location is required, the above algorithm may be modified, for e.g., to refine the approximate ridge line(s) by interpolating each ridge value with its adjacent node values in length and width dimensions.

The ridge line forms a ridge vector of values that is used subsequently to identify touches and to calculate touch locations.

The ridge line is used to locate touches, and it may also be used to report information in a format other than simple touch points. For example, the ridge line in FIG. 4 may be expressed as a parametric curve, for example using straight line segments or a Bezier or B-Spline function to condense the data required to describe the ridge of cluster 23. Width vector sums (the sum of all values in a vector) or an average of width vector sums may also be reported to a host system as part of a condensed description of the shape of a cluster.

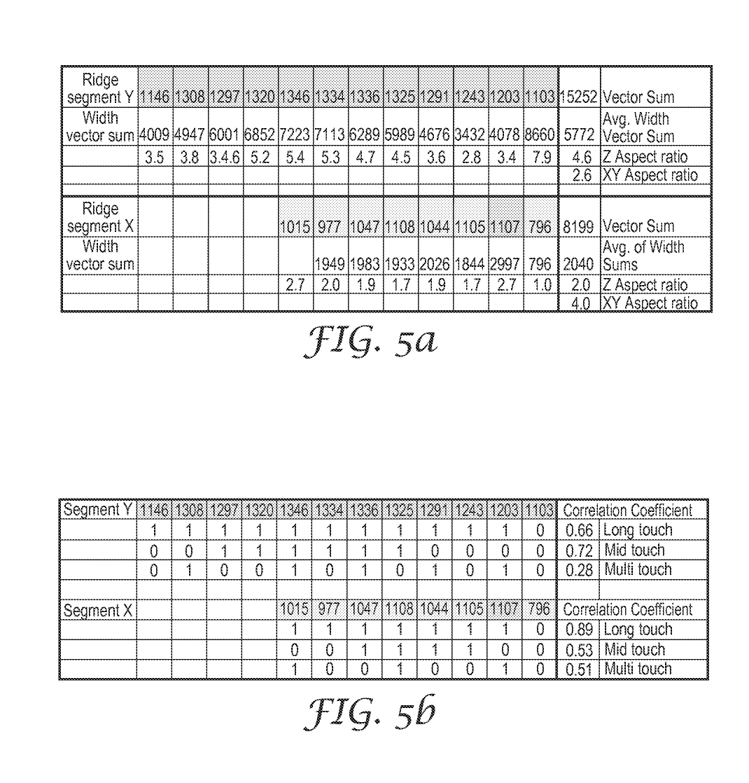

FIG. 5a is a table showing the values of the X-axis ridge vector shown in FIG. 4, along with the width vector sums of each ridge value. A width vector is the smaller of the X vector or Y vector that intersects at a specified node, as measured by vector sums (method used in all examples herein, unless otherwise noted), or by count of members in vector. Ridge segments are ridge lines with all width vectors in the same dimension. (For example, cells underlined FIG. 4 comprise one ridge segment, and cells italicized comprise a second ridge segment). The orientation of the ridge segments is different than the width vector, with width vectors of one ridge segment oriented in the X dimension, and most width vectors oriented in the Y dimension. Separating the ridge vectors can divide the data in FIG. 4 into two clusters.

In FIG. 5a, the average width vector sum of each vector is calculated. From this, an average Z aspect ratio and average XY aspect ratio are calculated. Z aspect ratio gives an indication of the cross section of the ridge. The Z aspect ratio of a typical fingertip touch is less than 2.5, so the large Z aspect ratio of ridge segment Y is probably not a finger touch. Ridge segment X has a Z aspect ratio in the range that may indicate fingertip touches. Calculated XY aspect ratios of the two ridge vectors are also shown. These may also be used to estimate the possible number of fingertip touches located in each cluster. A typical fingertip touch has an aspect ratio near 1, and rarely greater than 2. The XY aspect ratios of Y and X clusters are 2.6 and 4, which indicates the possibility of multiple touches.

The table shown in FIG. 5b shows the two ridge vectors of FIG. 4. Each vector undergoes a binary correlation, as follows, to form test vectors that will be correlated with the ridge segment to test for a single touch vs. multiple (#TchM) touches:

1.1.1. Correlate the ridge segment with a long touch binary vector of the same length, with values=all 1's except the position corresponding to the smallest value in the Ridge segment is 0.
1.1.2. Correlate the ridge segment with a mid touch binary vector of the same length, with half (rounded down) of the values=1's, centered on the largest value in the Ridge segment, and 0's in other locations;
1.1.3. Correlate the ridge segment with a multi-touch binary vector of the same length, with the quantity “A” of l's placed in positions corresponding to the highest values in the ridge segment, starting at the highest value, where A=aspect ratio, but is cannot be adjacent to one another.
1.1.4. Compare the correlation coefficients of the three correlations above.

1.1.4.1. If the mid touch binary vector and the multi touch binary vector have similar coefficients, a single touch is indicated.

1.1.4.2. If the multi touch binary vector yields the largest coefficient, multiple touches are indicated, with some touches near the locations corresponding to the is in the binary vector.

1.1.4.3. If the Long touch binary vector has the largest coefficient, a single touch is indicated.

A long touch binary vector has 1s in all positions, except the position corresponding to the smallest value in the Ridge segment is 0. A mid touch binary vector has half (rounded down) of the ridge segment values=1s, centered on the largest value in the ridge segment, and 0's in other locations. A multi-touch binary vector has a number of is equal to half of the number of values in the ridge segment. These 1ss are placed in positions corresponding to (and starting with) the highest values in the ridge segment, but 1s cannot be adjacent to one another. Correlation coefficients are calculated for each Y and X ridge segment, using the three binary vectors.

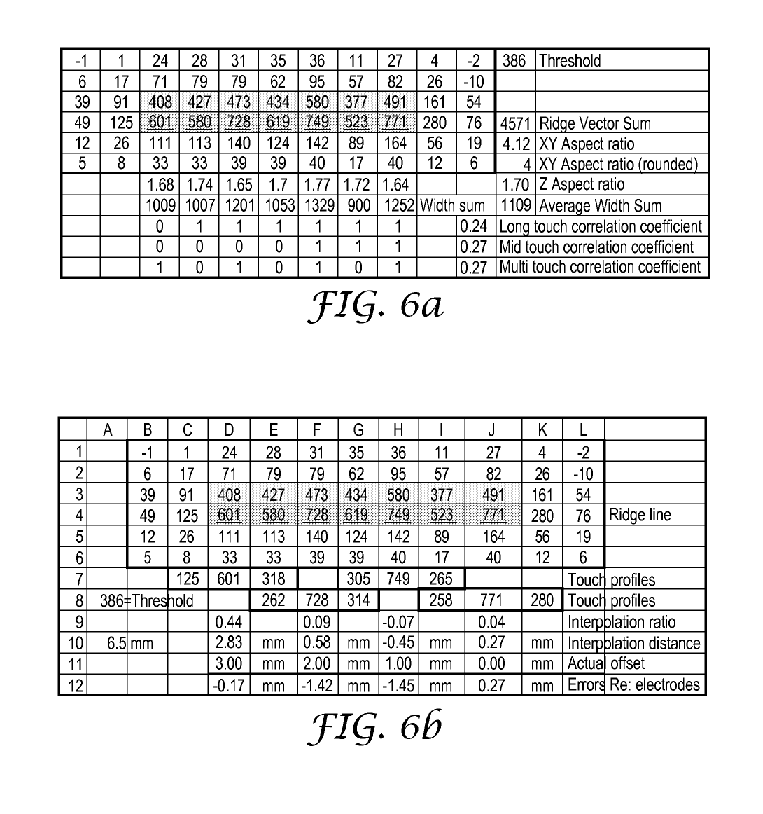

Other correlation approaches are possible. As previously stated, correlation with Gaussian curves more accurately matches real touches, but binary correlation is used in this example because it is simple and fast to calculate. The method of correlating against a full-length waveform, (long touch) then a half length waveform, (mid touch) followed by progressively shorter waveforms is similar to the process used in an FFT, and the objective of this set of binary correlations in FIG. 5b and FIG. 6a is similar to the objective of an FFT; to resolve (divide) a complex waveform into components that provide meaningful information.

The waveforms specified in exemplary steps 1.1.1 through 1.1.3 above are designed with the knowledge that finger touches (or a stylus) have a certain range of dimensions, (for example their minimum and maximum distance and width), relative to the touch sensor array, so only three correlations may be required to provide the necessary information to identify touches. If the system design and application is such that these assumptions cannot be made, then additional correlations can be made. For example, correlations may be made with between the array of measured values and waves with full length, half length, quarter length, etc. as is done in an FFT. Correlations may be done with the phases of the waveforms adjusted in a structured manner, (for example in two phases 90° apart) as is done in an FFT.

The magnitudes of the three coefficients indicates whether multiple touches are probably present in the ridge segment, and also provides approximate locations of the touch(s). In the examples in cluster that includes the Y segment, multitouch has lower coefficients than mid or long touch, so single touches are indicated.

Binary correlation of the whole Ridge vector (segment 1 and segment 2 combined) yields correlation coefficients of:
Long touch: 0.53,
Mid touch: 0.84,
Multitouch: 0.03.

So a single touch is indicated for the whole ridge.

Touch clusters may be reported to a host computer in any of several formats (all for illustrative purposes only):
A single touch centroid may be reported for the whole ridge line;
Centroids of the two ridge segments (FIG. 4, segment y and segment x) may be reported separately, e.g. the highest value of each may be used;
A parametric curve or straight line may be generated to describe the ridge segments;
Width vectors or an average width may be combined with a curve or line description to provide additional information;
All of the values may be reported.

Or, a touch may not be reported if parameters meet certain criteria. For example, analysis shows that ridge segment Y is too wide to be a fingertip touch or a stylus, so its presence may not be reported if the touch system is in a “palm rejection” mode. Similarly, ridge segment X is not fingertip or stylus touches so it may not be reported.

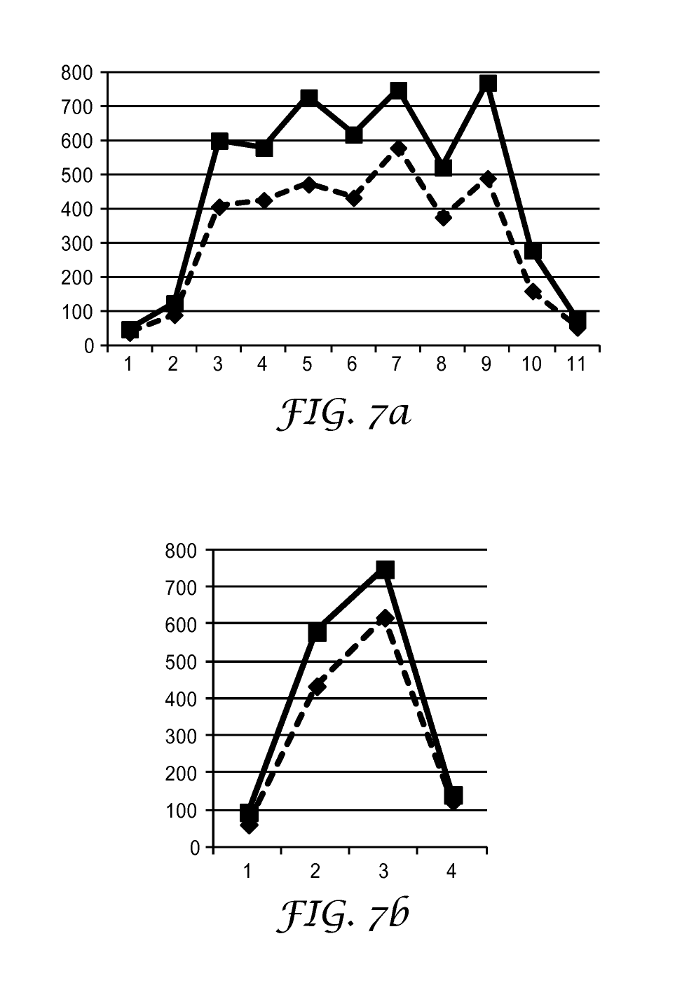

FIG. 6a shows an array of values of a four-touch cluster comprising a linear row of four touches, where each touch is 9 mm in diameter and touch centers are 12 mm apart. The ridge vector is shown in underlined type. A second >Th vector parallels the Ridge. FIG. 7a shows graphs of values measured from the cluster of values in FIG. 6a, including ridge values connected with a solid line and the second parallel vector values connected with dashed lines. FIG. 7b shows a graph of values of a width vector that intersects the highest (rightmost) peak of the graph in FIG. 7a.

The table in FIG. 6a also shows some analysis of the ridge. The ridge line vector algorithm, described above, identifies a ridge with seven values, oriented along the X axis. Width vectors are on the Y axis. The Z aspect ratio is below 2 so this ridge is not too wide to be multiple finger touches. The XY aspect ratio is greater than 4, indicating some probability of four touches on the ridge. The binary correlation algorithm, described above, indicates a probability of four touches on the ridge, and also indicates that a single touch is improbable. The three largest values would correlate even higher than the four selected, so confirmation of four touches by the XY aspect ratio is helpful.

Table 8a shows an array of values measured from a linear row of five touches, where each touch is 9 mm in diameter and touch centers are 15 mm apart. The ridge line algorithm was applied to this array, starting with the highest value, 933. This resulting in a ridge vector highlighted in underlined type. Values greater than the threshold, but not on the ridge are highlighted in italic type.

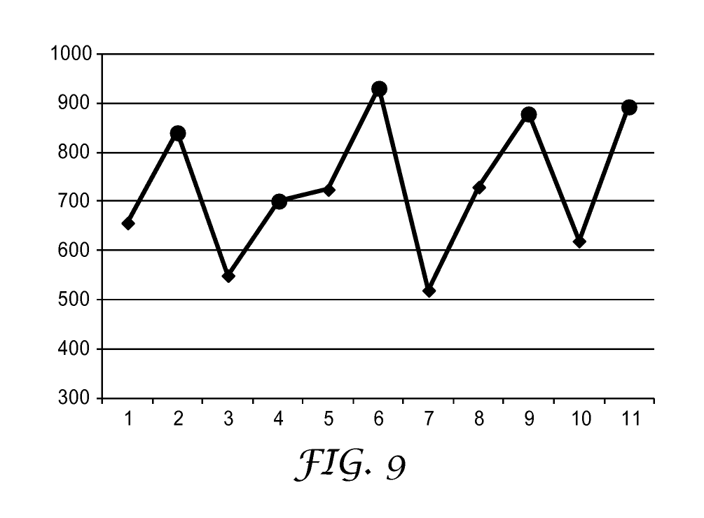

Table 8b shows the ridge line vector in linear form. The XY aspect ratio and Z aspect ratio are calculated. The long XY aspect ratio and small Z aspect ratio indicate that multiple touches are probable. Binary vectors are then prepared according to the algorithm described above, and the ridge line vector is correlated with the binary vectors. Correlation results confirm that a single touch is very unlikely, and five touches are indicated by 1s in the multi-touch binary vector shown in Table 8b. Values of the ridge in Table 8a are shown in FIG. 9, where black dots mark the correlated values.

### Hysteresis in Calculation of Width, Aspect Ratio, & Correlation

Hysteresis based on history may be used when applying the width, aspect ratio, & correlation algorithms described above. For example, when four touches were detected using the fact that the XY aspect ratio exceeds a threshold of four, then the threshold may be reduced to 3.5 for subsequent analysis, so a measured array of 3.8 would not result in a change from four to three to estimated touches. Similarly, the thresholds of X aspect ratio and average width may be changed during a touch event.

### Methods of Locating Multiple Touches

After touch locations are estimated by the methods described above, several methods of refining touch centroid locations within a cluster may be used, a few embodiments being described below. Where accuracy is not critical, Method 1 may be used, whereby the correlated values (corresponding to the 1s in the multi-touch binary correlation vector) are used as the centroids of the touch locations. This method is the simplest and fastest method so it is most useful when touches are moving. Method 2 also starts with correlated values, but then divides a ridge vector into individual touch profiles by re-apportioning each of the values that are between two correlated values. Re-apportioning may done by simple ratios of correlated values, by interpolation or by curve fitting. Method 3 also divides a ridge vector into individual touch profiles by re-apportioning values that are between two proximate touches, where re-apportioning is done by fitting to parametric curves, e.g. Gaussian.

### Method 1

### Binary Correlated Locations

If binary correlation shows multiple touches, one might assume touches are located directly over each electrode where a correlated value is located. In the four-touch example in table in FIG. 6, this method places four touches at equal distances (13 mm apart) along the ridge. Actual distance of touches is 12 mm, so if one end measurement is correct, the other 3 measurements would have errors of 1 mm, 2 mm, and 3 mm respectively, relative to electrode locations. The table in FIG. 6 shows results of binary correlations indicating multiple touches. Four values (601, 728, 749, and 771) are correlated values.

In this example, touch locations in the width direction may be further refined by methods of interpolation or curve fitting as described herein.

### Method 2

### Example 1—Interpolation

If binary correlation shows multiple touches, assume touches are located near each correlated value, then adjust the touch locations using interpolation. The table shown in FIG. 6b shows an example of inter-value interpolation of Method 1, using the four-touch cluster shown in the table shown in FIG. 6a. First, four values (601, 728, 749, and 771) on the ridge are selected as correlated values. The four correlated values and their neighboring values on the ridge vector will be apportioned into four individual touch profiles of three values each. Final calculated profiles are shown in bold type gray background.

Between each pair of the correlated values is one or more intermediate values that must be apportioned between two adjacent profiles. Apportionment in this example is done inverse to the relative magnitudes of the two correlated values. For example, the portion of the value in cell I4 that is apportioned to the 771 profile is 523*749/(749+771)=258 and the value that is apportioned to the 749 profile is 523*771/(749+771)=265. Linear interpolation was used in this example, although interpolation to other curves such as a Gaussian curve could be used.

After values of the four profiles are calculated, the centroid of each profile is calculated. The table shown in FIG. 6b shows results of linear interpolation ratios. These are multiplied by the distance between electrodes, (6.5 mm) to yield touch locations relative to electrodes. Given known 12 mm distance between touches, relative errors are calculated. Again, linear interpolation was used in this example, although interpolation to a Gaussian curve may yield better accuracy.

### Method 2

### Example 2—Interpolation

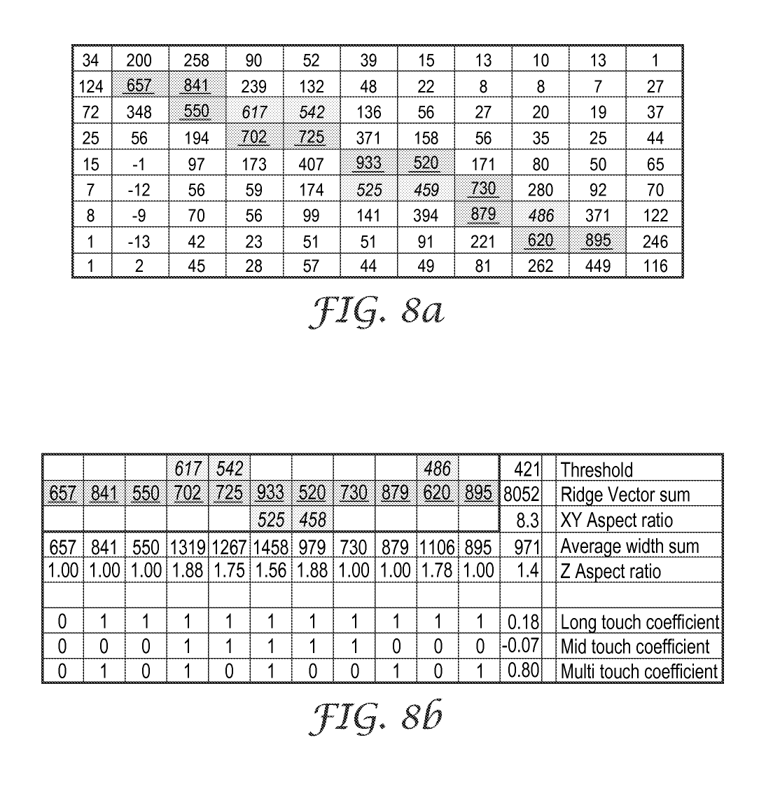

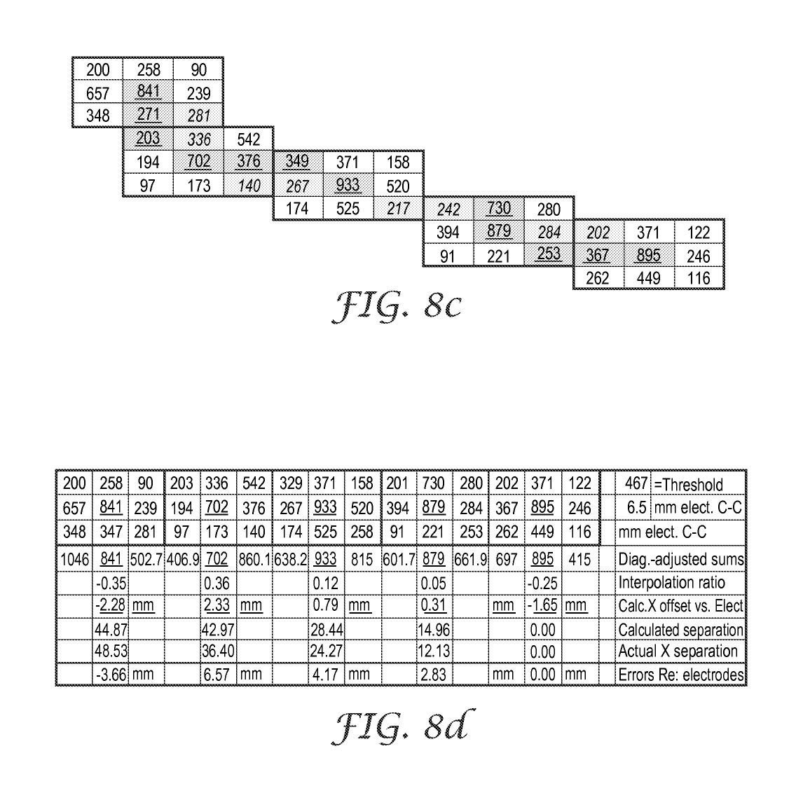

Interpolation is performed on the array in the table in FIG. 8a. Aspect ratios and binary correlation indicated five touches are present, (see table in FIG. 8b). Interpolation will be performed, centered on the five binary correlated values. Prior to interpolation, five groups of values are constructed. Each group comprises one of the five correlated values plus its eight surrounding adjacent values, (including diagonally adjacent). Some values are adjacent to two of the correlated values. These shared values (shown in italics in FIG. 8a) will be apportioned between the correlated values.

The table in FIG. 8c shows the values apportioned to each of the five correlated values. Apportionment was done using linear interpolation based on relative magnitudes of correlated values, and also on the distance between values. Values parallel-adjacent to a correlated value were with a weight of 1, whereas diagonally adjacent values were apportioned with a relative value of 0.707 to account for their greater diagonal distance. For example, the value 620 was apportioned to 59.3% to the adjacent correlated value 895, and 40.7% to the diagonally adjacent correlated value 879. Apportionment by interpolation based on a Gaussian curve may be more representative of the actual relative signal strengths of the two touches.

The table in FIG. 8d shows interpolation in the X dimension of the five groups of values arranged in line. Interpolation of the centroid of each touch may be done including or not including the diagonal values. The table calculations include the diagonals, so in each group, three values to the left and three values to the right of each correlated value are diagonally-adjusted, then added. For example, in the left-most column, values 200 and 348 are each multiplied by 0.707, then added to the value 657 to yield 1046. The summed values to the left and right of each correlated value are then interpolated to yield an interpolation ratio indicating a deviation proportional to the distance between electrodes. Alternatively, interpolation may be calculated using only the values to the left and to the right of each correlated value, for example the left-most interpolation ratio may be based on the values 657 and 239, resulting in a ratio of −0.47. Offset distances may be calculated from interpolation ratios and the known distance between electrodes, which is 6.5 mm in this example.

Absolute errors cannot be measured because absolute position of the touches in this example was not known. But distance between electrodes is known to be approximately 15 mm, so separation errors are calculated, as further described with respect to, e.g., FIG. 8d.

### Method 2

### Fitting to a Curve, e.g. Gaussian

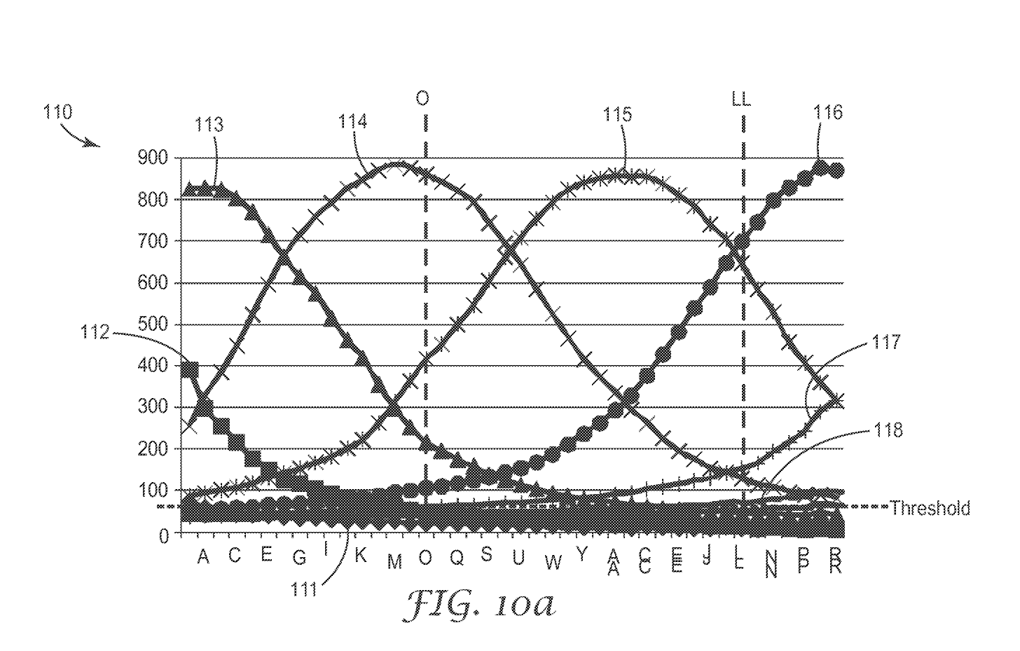

FIG. 10a shows graph 110 of data measured on a 3M mutual capacitance type touch screen. An electrically grounded conductive cylinder was dragged horizontally across the touch screen surface at a relatively constant rate, and measurements were taken from each column electrode of the touch screen as the cylinder passed over. Columns were linked 4 mm diamonds, 6.5 mm apart center-to-center, and the cylinder was 9 mm diameter. Curves 111-118 show the measurements from 8 column electrodes. During this test, the cylinder passed directly over, and was momentarily centered on four electrodes, indicated by peaks of curves 113-116.

The location of the cylinder at every point along its path can be determined from the combination of measurements of the eight electrodes, or of a subset of the eight. For example, the profile of measurements at point O on the horizontal axis (intersecting dashed line “O”) and the profile of measurements at point LL (dashed line LL) are listed in Table 1, below, and graphed in FIG. 2b.

TABLE 1

Measurements

| Curve | Location O | Location LL |
|---|---|---|
| 111 | 21 | 9 |
| 112 | 48 | 13 |
| 113 | 216 | 46 |
| 114 | 860 | 128 |
| 115 | 416 | 647 |
| 116 | 106 | 699 |
| 117 | 61 | 153 |
| 18 | 44 | 70 |

Curves 113, 114, 115, and 116 in FIG. 10a have a bell shape similar to a Gaussian or normal curve, and analysis of data indicates that a Gaussian curve can be a good approximation for the data measured on typical touch screens. Alternative curves include quadratic, hyperbolic, square cosine, inverse tangent, and a function of the distance between a charged sphere and a conducting plane, as described in co-pending US Patent Application Publication No. 20080106520.

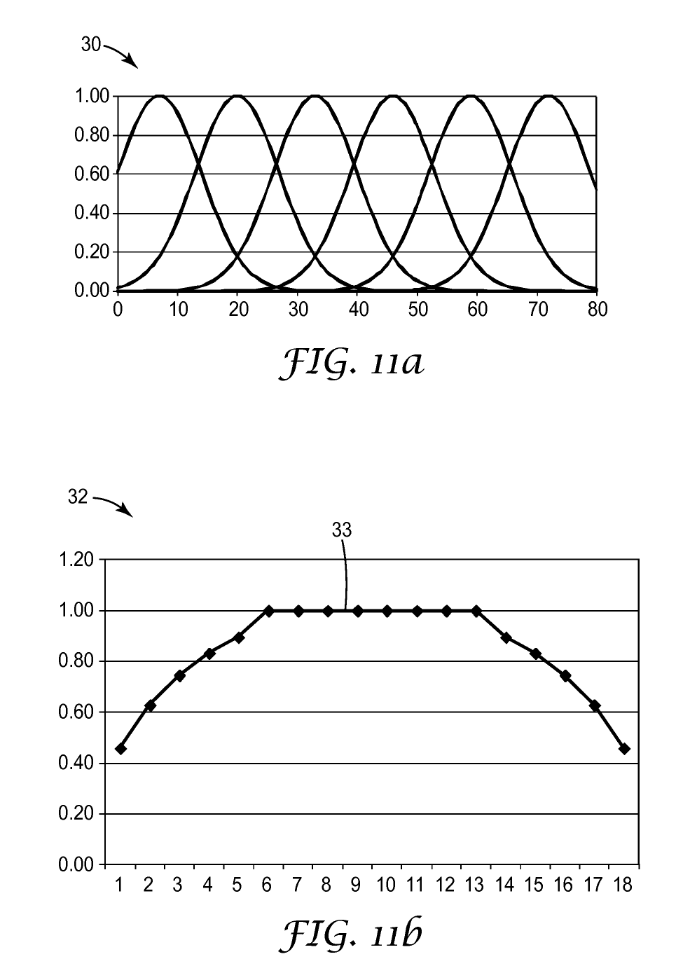

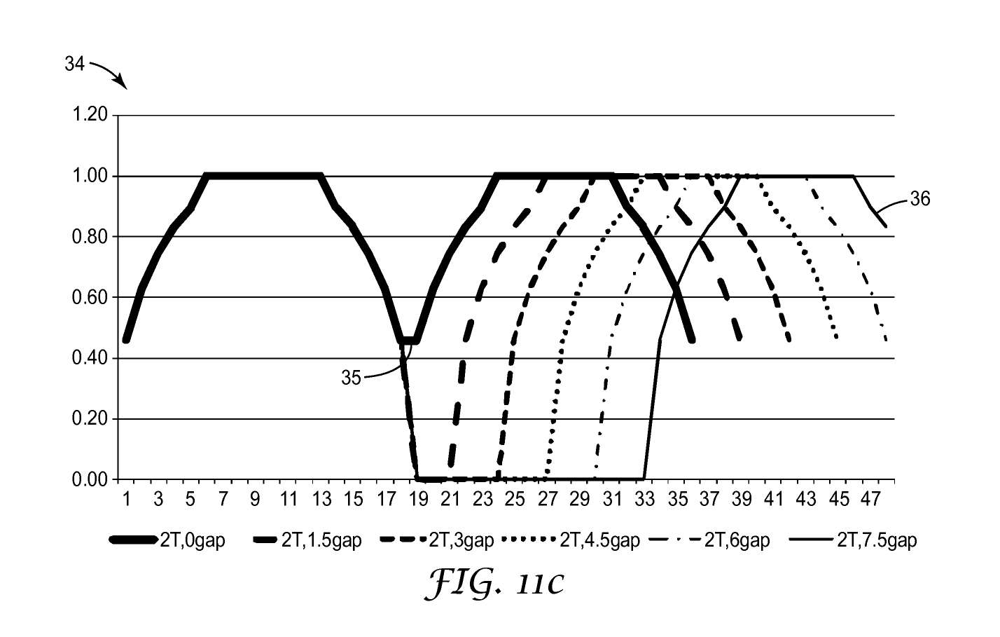

FIG. 11a, graph 30, shows similar curves as those shown in FIG. 10a, but that were generated (simulated) using a normalized Gaussian distribution formula, with means separated by 13 units, where each unit can represent 0.5 mm (so simulated data matches the scale of measured data). Standard deviation of the data set represented in FIG. 11a is 7, a distribution selected to generate measured signals versus distance that simulate measurements from a very narrow touch on electrodes having a width of approximately 5 units (e.g. 2.5 mm) average.

FIG. 11b is graph 32 showing curve 33, which approximately simulates the capacitive coupling profile (in cross section) of a round touch of 18 units (e.g. 9 mm) diameter.

FIG. 11c shows graph 34, which includes curves 35 that simulate the capacitive coupling profiles (in cross section) of pairs of round touches of 18 units (e.g. 9 mm) diameter, with various separations. Separation of the touches in each pair ranges from 0 units, designated “2T,0gap” to 15 units=7.5 mm, designated “2T,7.5gap”. These simulated touch curves were combined with the simulated electrode capacitance curves shown in graph 30, using vector dot product multiplication.

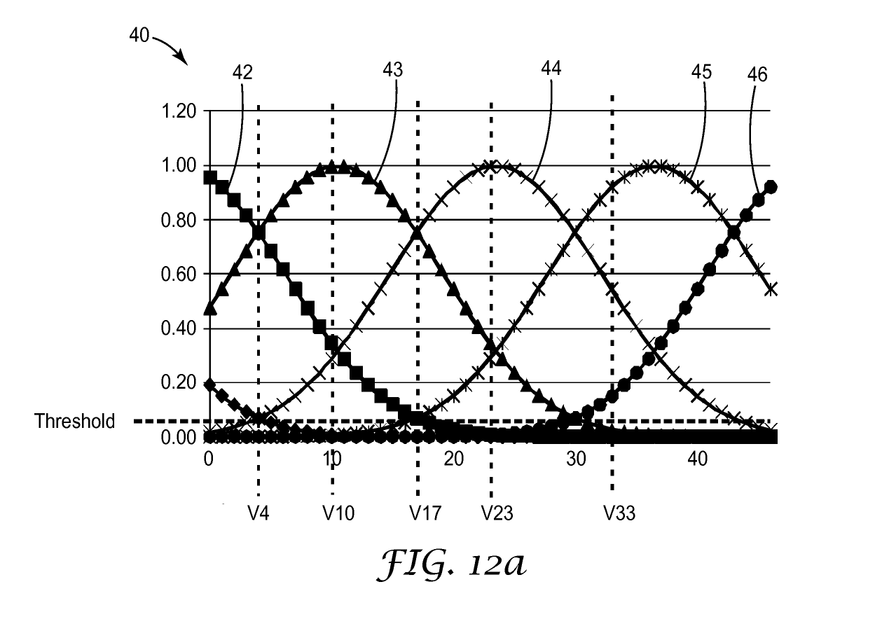

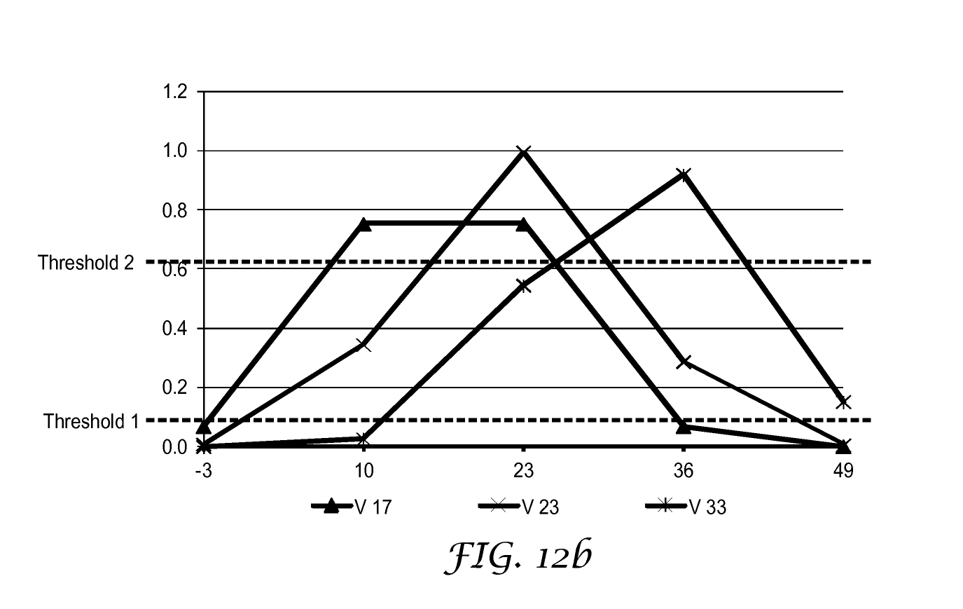

Table 2 is a simulation of the measurements shown in FIG. 12a (which is in turn a section of the curves 30 shown in FIG. 11a).

TABLE 2

| | | | | | |
|---|---|---|---|---|---|
| E1 | .07 | .01 | .00 | .00 | .00 |
| E2 | .75 | .34 | .07 | .01 | .00 |
| E3 | .75 | .99 | .75 | .34 | .03 |
| E4 | .07 | .29 | .75 | .99 | .54 |
| E5 | .00 | .01 | .07 | .29 | .92 |
| E6 | .00 | .00 | .00 | .01 | .15 |
| | V4 | V10 | V17 | V23 | V33 |

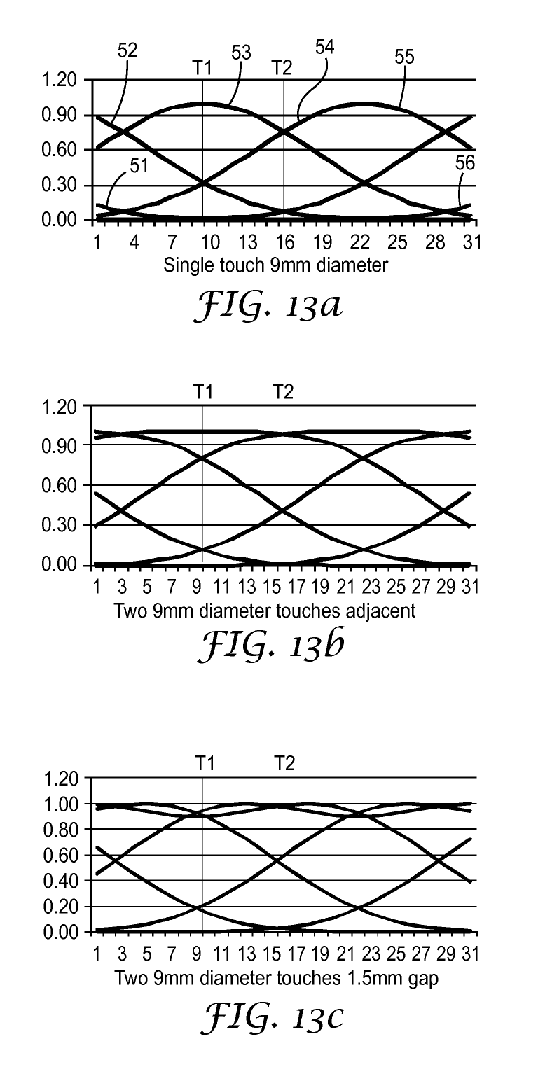

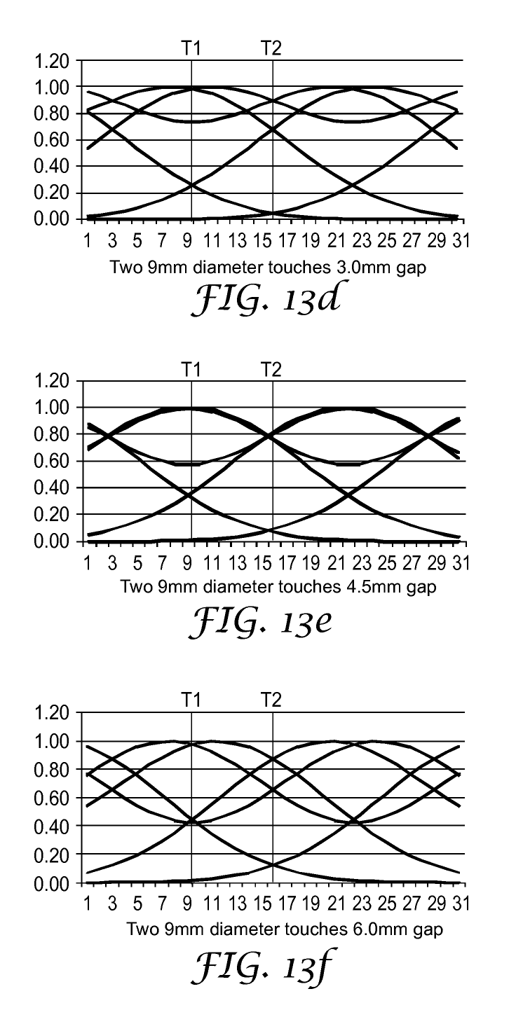

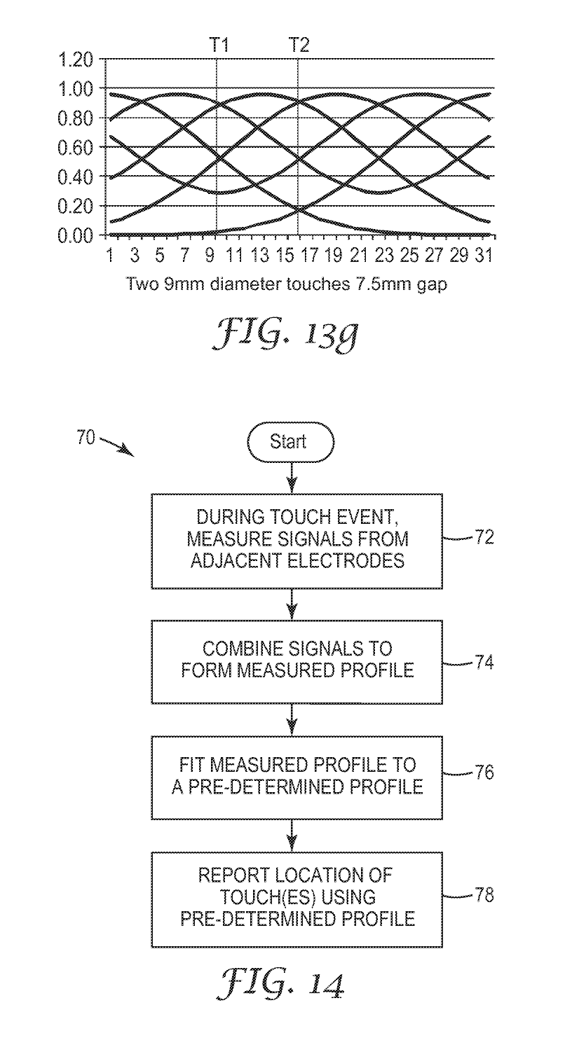

Table 2 shows a series of 47 dot products of the curves in graph 40 (FIG. 13a) and simulated single-touch curve 33 (FIG. 12b). Each of the 47 data points represent simulated measured results of measuring a touch located at evenly spaced locations relative to a set of six simulated electrodes, E1-E6. The spacing between data points is intended to simulate 0.5 mm so 13 spaces between peaks simulates 6.5 mm spacing between electrodes. At each location, five data values (V4, V10, V17, V23, and V33 as shown in FIG. 12a) are “measured”, and these five values form a profile that describes the touch location.

Five of the profiles are numerically listed in Table 2, for locations 4, 10, 17, 24, and 33. Profiles at locations 4 and 17 have the same measured values, but the values are shifted by one inter-electrode space (6.5 mm). It is apparent from the curves that measurements will repeat in value for successive electrodes, e.g. each electrode in succession will reach a maximum measured value when a single touch is centered on that electrode, and adjacent electrodes will have equal measurements when a touch is located between them.

The 47 dot products are calculated as the 18 unit wide simulated touch curve 33 is scanned across the 80 unit wide curves (as shown in graph 30 (FIG. 11a). The first dot product is calculated with curve 33, data point 0 aligned with curves shown in graph 30, data point 0. The next dot product is calculated with curve 33, point 1 aligned with curves shown in graph 30, point 1, and so forth until all 47 dot products are calculated, simulating the dragging of a touch across electrodes.

Simulated curves shown in graph 30 (FIG. 11a) may be compared to measured curves shown in graph 110 (FIG. 10a). Both sets of curves have similar a normal shape. Below the peak of each curve, the two adjacent curves cross one another. Where the adjacent curves cross, they have a magnitude approximately ⅓ of the peak magnitude, (e.g. cross-over is approximately 300 at coordinate M and BB of graph 110). Each pair of adjacent curves cross over one another with a magnitude of about 75% of the peak values, (e.g. peak 114=890 at coordinate M, cross-over=680 near coordinate T). Below this higher cross-over point of adjacent curves is a lower cross-over of curves that are three peaks apart. The lower cross-over in the measured data is at about 15% of the peak values, whereas the lower cross-over is at about 8%. This difference between measured and simulated data may be partially attributed to capacitive fringe fields that couple to more distant electrodes. Fringe fields were not simulated in the exemplary simulated data. The similarity between curves shown in graph 110 and the curves shown in graph 130 confirms that the simulated 9 mm touch is an adequate analog of measured data, for purposes of this disclosure.

FIG. 12b is a graph of the three measured profiles at locations V17, V23, and V33 shown in FIG. 12a. The graph of the V23 profile shows a high centered peak with two nearly equal adjacent values on either side of the peak, indicating V23 is nearly centered on an electrode. The graph of V17 profile has two nearly equal maxima, characteristic of a location between two electrodes. V33 is about half way between being centered on an electrode and being between two electrodes, and its skewed graph has characteristics that are between those of V17 and V23 graphs.

The values in profiles V17, V23, and V33 (FIG. 12b) comprise data points on Gaussian curves. The Gaussian shape is less apparent than curves 42-46 in FIG. 12a, because data points in V17, V23, and V33 are separated by 13 units, (simulating 6.5 mm electrode spacing) whereas curves 42-46 are simulated with 1 unit (0.5 mm) spacing, simulating a touch dragged 0.5 mm between measurements. FIG. 13 shows graphs 13a-13g, showing the result of “dragging” simulated single and dual touches across simulated electrode signals. By dual, or multi-touch, what is meant is more than one temporally overlapping touch events. In all dual touch simulations, the axis of the two touches is oriented perpendicular to the measuring electrodes E1-E6, (i.e. the two touches are oriented parallel and aligned to a row electrode, while measurements shown in graphs 13a-13g are made on column electrodes). All touches are 9 mm diameter. Graph 13a shows simulated electrode signals resulting from a single touch, (FIG. 13a shows a subset of data points of the curves shown in FIG. 12a). Graph 13b shows measured signals resulting from dragging two touches with no gap between them, (2T,0gap). Curves are much broader than those of a single touch, as might be expected. Graph 13c shows measured signals resulting from two touches with a 3 unit (e.g. 1.5 mm) gap between them. Graph 13d shows measured signals resulting from two touches with a 6 unit (e.g. 3 mm) gap between them. Curves of graph 13c and 13d are much broader and they are no longer Gaussian in shape. Instead they have an appreciable concave mid section. This concave midsection becomes increasingly prominent as inter-touch gaps increase from 4.5 mm in FIG. 6e to 7.5 mm in graph 13g.

Graph 13g curves simulate signals measured from two touches with a 7.5 mm gap between. The concave middle of each curve is so pronounced that each curve starts to resemble two separate Gaussian curves. At separation distance greater than 7.5 mm, the locations of the two touches may preferably be calculated independently. However, for the multiple touches with inter-touch spacing from zero to about 6 to 8 mm, (separation of about 1 electrode width) the two touch locations may be determined by a combined calculation, for example a correlation function.

Given a library of model profiles of dual touches, for example those shown in graphs 13a-13g (or equivalent measured profiles gathered during a calibration process), touch locations of dual touches (T1 and T2) may be identified by correlating measured data with model profiles.

The dual-touch data of the exemplary simulations include measurements from up to six electrodes. Practical touch sensors may incorporate 60 or more electrodes in each dimension. A simple algorithm may be used to find a coarse location. For example, inspection of graphs 13a-13g appears to show that waveforms repeat every 13 units, which is the distance between each pair of electrodes E1-E6. Actually, waveforms repeat every 6.5 units, alternately flipping to a mirror image of adjacent values. Within each repeating segment, the highest electrode measurements identify which electrodes are closest to the touch(es), and also indicate whether the centroid of touch(es) is closer to an electrode center or closer to being centered between two electrodes, as illustrated in FIG. 12b. Given algorithmic identification of a coarse centroid location within ½ of an inter-electrode space, correlation models may be used only within that distance.

Lines V10 and V17, (FIG. 12a) are separated by ½ of an inter-electrode space, so the profiles indicated by their intersecting points with all curves in 13a-13g will provide the extremes between which touch data can be correlated. In FIG. 12a lines V10 and V17 indicate the centroid of a single touch. In FIGS. 13b-13g the corresponding points T1 and T2 indicate the centroid of two identical touches, corresponding to the middle of the gap between the two touches. Line T1 indicates touch(es) at point 10, corresponds to the point V10 of FIG. 12a, which is nearly centered on simulated electrode E3, (a measured point at 10.5 would be more precisely centered on E3). Line T2 indicates touch(es) at point 17. This corresponds to the point V17 of FIG. 12a, which is nearly equidistant between electrodes E3 and E4.

Each pre-determined profile will uniquely define the location of the touches within a previously determined coarse location. By correlating each profile with its closest matching profile among pre-stored model touch data, the locations of touches can be derived.

Measured profiles may be correlated with a set of stored model profiles to determine touch coordinates. Model profiles are sets of data that match the relative magnitudes of typical measured touch data under certain conditions. Different model profiles are required to match different touch situations. For example, a library may include sets of profiles for 6.5 mm electrodes in proximity with 7 mm diameter touches, as well as 8 mm, 9 mm, 10 mm, and 11 mm touches, i.e. the full range of expected finger touches. Each diameter specific set may include a number of situations including a single touch, and dual touches with various separations (gaps) between them, and more than two touches. And for each touch situation, the library may provide multiple profiles representing various inter-electrode offsets. FIG. 12b shows examples of a single 9 mm touch at three different offsets.

Curves shown in the graphs of FIG. 13 show data that may be used to make a set of profiles for 9 mm diameter touches in proximity with 6.5 mm spaced electrodes. Each of the seven touch situations in FIG. 13 may be fully described by samples of data between T1 and T2, i.e. between location V10 and location V17, inclusive (referring to FIG. 12a and Table 2). The eight profiles V10-V17 represent samples offset 1 mm apart. These may all be stored, or a subset may be stored. Interpolation of correlation coefficients may be used to increase resolution.

Alternatively, profiles may be calculated by generating a Gaussian curve of appropriate standard deviation to represent a desired touch width, and sampling the curve at points corresponding to electrode center-to-center spacing, as was done for the examples herein.

A database library may include sets of models for special cases such as the large touch of a palm on the screen, or a stylus profile may be used to locate the tip of a stylus, or a stylus tip in close proximity with a finger touch may be modeled.

Most of the examples and discussion herein focuses on a single dimension. The coarse location calculations, correlation calculations, and other function descriptions apply equally to both dimensions and the calculations must be performed in both dimensions of a 2D touch screen. One of the first calculations required is the determination of aspect ratio of a touched area. The total area of touch-proximate electrodes may be determined by determining a contiguous group of above-threshold measurements. The threshold may be a fixed value, or it may be calculated by finding a peak magnitude of touch, then determining the nearest contiguous group of measurements that are greater than a certain percent of the peak, e.g. all measurement that are at least 10% as large as the peak.

The aspect ratio of the above-threshold area may then be determined by dividing the length of the area by its width. Length and width may be aligned with the electrodes of the touch screen, or they may be on any angle with respect to electrodes. Length may be a straight line or it may be on a curve, following the ‘ridge line” of maxima through the touched area. For most embodiments of this invention, touches are assumed to be round, i.e. with an aspect ratio near 1, or another number that is unlikely to include two or more touches. For example, an aspect ratio less than 1.6 might be assumed to be a single touch.

Having determined a coarse location and having selected appropriate correlation models, the correlation models may first be scaled to the size of the touch. The aspect ratio of the touch area is calculated, and the narrow dimension is assumed to be the dimension of a single touch. The dimensions of pre-stored (or calculated) single-touch curve models may then be selected to match the measured profile of the width dimension. This may be done with a Gaussian curve fitting algorithm or by mathematically correlating the measured width data with single-touch models of various widths. Algorithm 1 describes a coarse curve fitting algorithm that helps to select the best single-touch model.

Special cases may also be handled prior to correlating, or instead of correlating. For example, if a touch area is wider or much narrower than a normal touch, a different set of models may be used for correlation. For example, a Palm algorithm may be used to correlate profiles that match those of a palm on the screen, or a stylus profile may be used to locate the tip of a stylus. Alternatively, a large touch such as a palm or a cheek touch may be handled with an alternative algorithm not including correlation. After the measured width profile has been correlated to the best-fit single-touch model profile, models from the same set (the same touch diameter) are correlated with measurements from the length dimension of the touch area. This is done by mathematically correlating the length profile with known, pre-stored models, for example the models shown in FIG. 6. Length/width of the touch area can be used as an indicator of which models are most likely to correlate with the measured data. For example, a length/width of 2 may indicate a dual touch model will fit best, and length/width of 3.5 may indicate a three touch model is appropriate, (or two concatenated 2-touch models).

Table 3 shows a table of correlation functions calculated for each of the curves in FIG. 13, versus all of the other curves in FIG. 13, where the centroid is at point 10 (aligned with line T1). The table indicates the sensitivity with which various touch separations can be discriminated form one another based on correlation functions, using the methods described above. The correlation function of a single touch vs. two adjacent touches (no gap) is 0.85, differing by 15% from a single touch. Two touches with a 3 mm gap differs from two touches with no gap by 11%, with a correlation function of 0.89. These numbers are based on correlation of the four largest values in each profile. Table 3 shows correlations of two profiles whose centroids are aligned, centered on point T1, (FIG. 13). In practice alignment must be done. Correlation functions may be used for this also.

TABLE 3
Profiles Correlation with one another, centroid = T1

| | | | | | | | |
|---|---|---|---|---|---|---|---|
| 2 Touch; | −0.39 | 0.16 | 0.36 | 0.59 | 0.79 | 0.93 | 1.00 |
| 7.5 gap | | | | | | | |
| 2 Touch; | −0.05 | 0.49 | 0.66 | .083 | 0.95 | 1.00 | 0.93 |
| 6.0 gap | | | | | | | |
| 2 Touch; | 0.26 | 0.73 | 0.86 | 0.96 | 1.00 | 0.95 | 0.79 |
| 4.5 gap | | | | | | | |
| 2 Touch; | 0.51 | 0.89 | 0.97 | 1.00 | 0.96 | 0.83 | 0.59 |
| 3.0 gap | | | | | | | |
| 2 Touch; | 0.71 | 0.98 | 1.00 | 0.97 | 0.86 | 0.66 | 0.36 |
| 1.5 gap | | | | | | | |
| 2 Touch; | 0.85 | 1.00 | 0.98 | 0.89 | 0.73 | 0.49 | 0.16 |
| 0.0 gap | | | | | | | |
| 1 Touch | 1.00 | 0.85 | 0.71 | 0.51 | 0.26 | −0.05 | −0.39 |
| | 1 Touch | 2 Touch; | 2 Touch; | 2 Touch; | 2 Touch; | 2 Touch; | 2 Touch; |
| | | 0.0 gap | 1.5 gap | 3.0 gap | 4.5 gap | 6.0 gap | 7.5 gap |

Table 4 shows a table of correlation functions of the waveform 2T 1.5 gap, (simulation of two 9 mm dia. touches separated by a 1.5 mm gap), as measured at point T1 (FIG. 6). In the third row from the top, (in bolded italics) waveform (2 Touch; 1.5 gap) is correlated with itself, as one instance of the waveform is fixed and the other is offset various distances from −2 mm to +7 mm. Other rows of Table 6a show correlation functions of other waveforms correlated with the waveform (2T 1.5 gap), with various offsets. The other waveforms are centered on V10.

TABLE 4
Centroid offset from location T1 (mm)

| | | | | | | | | | | |
|---|---|---|---|---|---|---|---|---|---|---|
| 1 Touch | 0.72 | 0.71 | 0.71 | 0.71 | 0.71 | 0.71 | 0.71 | 0.71 | 0.69 | 0.67 |
| 2 Touch; | 0.97 | 0.98 | 0.98 | 0.97 | 0.95 | 0.93 | 0.90 | 0.85 | 0.80 | 0.73 |
| 0.0 gap | | | | | | | | | | |
| 2 Touch; | [symbol] | [symbol] | [symbol] | [symbol] | [symbol] | [symbol] | [symbol] | [symbol] | [symbol] | [symbol] |
| 1.5 gap | | | | | | | | | | |
| 2 Touch; | 0.95 | 0.97 | 0.97 | 0.96 | 0.93 | 0.90 | 0.84 | 0.77 | 0.69 | 0.59 |
| 3.0 gap | | | | | | | | | | |
| 2 Touch; | 0.83 | 0.86 | 0.86 | 0.86 | 0.83 | 0.79 | 0.74 | 0.67 | 0.58 | 0.48 |
| 4.5 gap | | | | | | | | | | |
| 2 Touch; | 0.63 | 0.65 | 0.66 | 0.66 | 0.64 | 0.60 | 0.55 | 0.48 | 0.40 | 0.31 |
| 6.0 gap | | | | | | | | | | |
| 2 Touch; | 0.34 | 0.36 | 0.36 | 0.36 | 0.34 | 0.30 | 0.24 | 0.17 | 0.09 | 0.02 |
| 7.5 gap | | | | | | | | | | |
| | −1.00 | −1.00 | 0.00 | 1.00 | 2.00 | 3.00 | 4.00 | 5.00 | 6.00 | 7.00 |

An offset of 1 mm in the model shown in Table 4 has a 1% effect at the T2 location, and a negligible effect at the T1 location. At both locations, it is apparent that a difference of 1.5 mm of touch separation has a greater effect on correlations than a similar change in offset of the pair of touches.

In some cases correlation sensitivity may be increased by emphasizing the middle level values of profiles. This may be done by filtering the profiles or fewer terms may be used for the correlation, (e.g. the highest and lowest values in a profile may be omitted). For example, a profile comprising 5 above-threshold measurements may be used for initial correlations, then highest and lowest measurements of measurement profiles and model profiles may be omitted, and correlations may be done with only the middle 3 values. For example, FIG. 13 graph 5e has six curves that intersect the location line T1 indicating the 6 values that would be measured at T1. If location T1 were shifted from location 1 to 9 or 11, the curves that intersect at about 0.35 would change significantly, but the two curves near 1.00 and the curves near 0.6, and 0.0 would change little. At all locations, the highest sensitivity to offset is generally found in the measurements in the range of 0.2 to 0.8.

Using correlation functions in this way is somewhat similar to Fast Fourier Transforms, (FFTs). where Gaussian curves are used instead of sine wave frequencies, and the offsets are used in place of phases. Algorithms below show embodiments of the invention that may be used to locate multiple touches in close proximity.

FIG. 14 shows a flowchart 70 illustrating one exemplary manner in which correlation may be used to determine locations of one or more touches on a matrix-type touch sensor. First, signals are measured across multiple adjacent electrodes during a touch event (step 72). These signals are combined to form a measured profile (74) along a Ridge line of measured maxima, which may be provided to a computer system. Ridge line values are then compared with a set of pre-determined profiles (76) using a correlation function. Either the best matching profile is thus determined, or, if there is one tested pre-determined profile that fits particularly well (high enough correlation), other pre-determined profiles may need not be checked, and the one tested pre-determined profile is used. The pre-determined profile is then used to determine touch locations (step 78), which may be provided to a computer system. The process shown in FIG. 14 would result in location coordinates along a ridge line that follows a contiguous set of maximum above-threshold values, resulting in X and Y coordinates of the one or more touches. Algorithm 1 shows additional detail of flow chart 70.

Algorithm 1—Threshold Shapes, Aspect Ratio, and Fixed Models
1. Find touch area=contiguous measurements above a threshold
   1.1. Threshold=fixed level or % of peak value, surrounded by less-than-threshold measurements
2. Find aspect ratio (AR) of touch area—Max length & maximum width (MaxW)
   2.1. Use comparison vs. a fixed threshold or vs. a % of maximum measurements
   2.2. Length may be a straight line or curve, (length follows the “ridge line” of maxima)
3. IF aspect ratio of a segment is less than 1.7 OR if width>>finger, THEN
   3.1. Identify centroid of segment=touch point. ELSE:
4. Select models based on Max width (MaxW) dimension, & profile, & edge proximity
   4.1. Coarse width (S.D.) calc.=((2 highest measurements)/(all above-threshold measurements)) is in a range W+/−w % [OR other formula that estimates an approximate curve shape]
      4.1.1. May have 2 or more segments of different widths along a length
      4.1.2. Depends on touch width & on electrode spacing
   4.2. Fine calc=Correlate to closest matching of set of model curves
      4.2.1. Gaussian curves (for finger) or stretched Gaussian (for palm), (or other)
5. Correlate length:
   5.1. Coarse length: Aspect ratio of touch area identifies a set of models most likely to correlate well, (e.g. 2+:1 aspect ratio is most likely to match 2-touch models, 3+:1 is more likely to match 3-touch models, etc).
   5.2. Coarse length: (S.D.) calc.=(2 highest measurements/all above-threshold measurements) is in a range L+/−1% [OR other formula that estimates approx curve shape] helps to further refine the selection of best models to use
      5.2.1. Depends on electrode spacing & touch(es) length
   5.3. Fine calc=Correlate to closest matching Model curves, (e.g. if width=9 mm Gaussian, the set of Gaussian curves in FIG. 6 would be used)
      5.3.1. Correlate models with various shifts in position
   5.4. Select model profile with the Max correlation coefficients, and the offset position that yields the highest correlation coefficient

If necessary, interpolate between two Max correlations to find touch locations.

A variation of this algorithm would be to limit the set of profiles to one and two touch profiles, then concatenate existing profiles to cover 3+ adjacent touches.

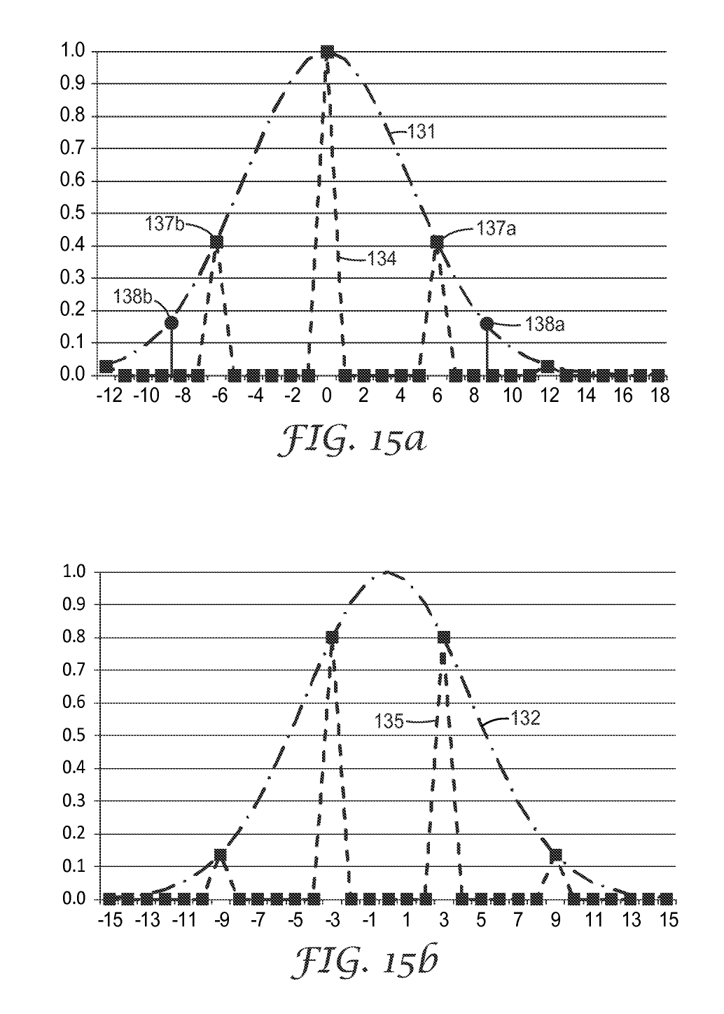

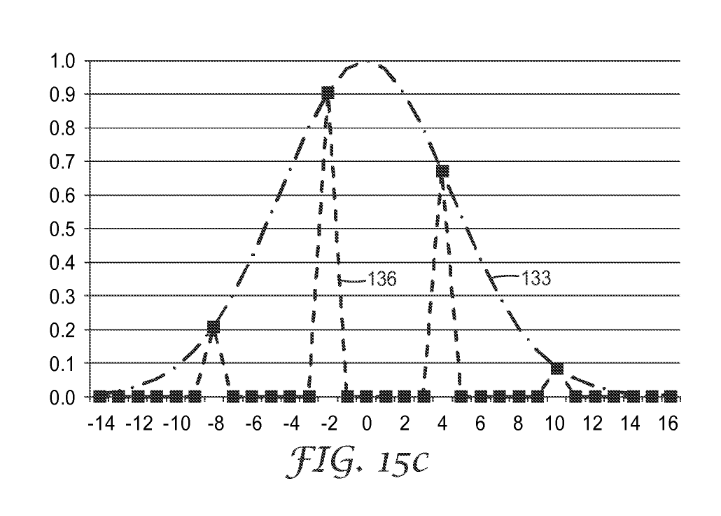

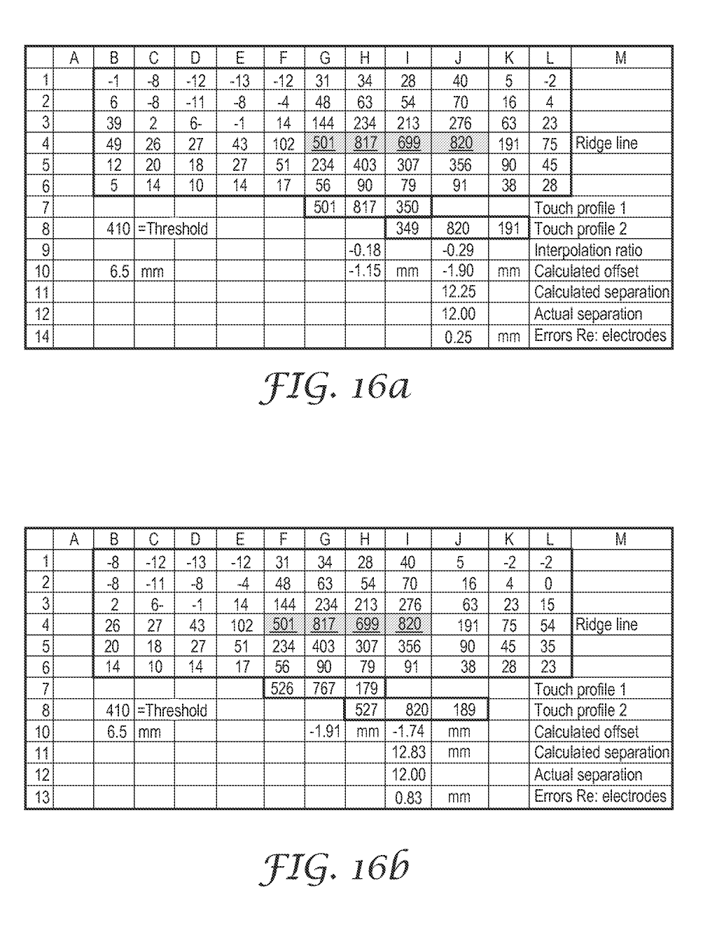

FIGS. 15a, 15b, and 15c show dot-dashed Gaussian curves 131, 132, and 133 respectively, representing a value of capacitive coupling to an electrode vs. distance from the electrode, as measured on a touch surface. These curves are exemplary and not intended to apply to any specific touch system, but they are typical of a touch screen with electrodes 6 mm apart, proximate to a touch of 8 to 10 mm. The curve magnitudes are normalized to a peak value of 1.0. Their standard deviation is 4.5.

The dashed curves 134, 135, and 136 indicate signal strengths that would appear on touch-proximate electrodes spaced 6 mm apart. For example, FIG. 15a shows a touch directly over the electrode E0 at coordinate 0. The value of capacitive coupling to electrode E0 is greater than to electrodes E6 and E-6 at coordinates +6 mm and −6 mm respectively. Signal values 137a and 137b at E6 and E-6 are 41% of the value at E0. Values at electrodes E12 and E-12 are 3% of the value at E0.

Given that adjacent electrode intersections are 6 mm apart, diagonally adjacent intersections will be 1.41×6 mm=8.5 mm apart. Points 138a and 138b are at a distance of 8.5 mm from electrode which represents the signal strength at a diagonally adjacent intersection. Signal values 138a and 138b are 17% of the value at E0. The ratios of 17% vs. 41% may be used when apportioning intermediate values prior to interpolation or Gaussian curve fitting calculations. For example the Gaussian ratio could be used in apportioning diagonally adjacent values, as described with respect to FIG. 8c and FIG. 8d.

FIG. 15b shows a touch equidistant between two electrodes. Values measured on the two closest electrodes E3 and E-3 are equal, and the ratio E9/E3 (or E-9/E-3) is 0.17. Changing the standard deviation (SD) from 4.5 to 5 (due to a wider touch area) would change the ratio E9/E3 from 0.17 to 0.24. FIG. 15c shows a touch offset 2 mm from the closest electrode. The ratios of values measured on the four closest electrodes are E4/E-2=0.74, E-8/E-2=0.23, and E-8/E4=0.31.

These ratios are unique to the touch offset relative to electrodes, so the offset (i.e. location) of a touch relative to electrodes can be calculated by fitting an appropriate curve (e.g. Gaussian) to values measured from electrodes. Two or more touches in close proximity can be accurately located fitting two or more overlapping curves having the right parameters.

Method 3 Summary:

In Method 3, For multiple adjacent touches, (a high aspect ratio), signals of two or more touches may be disambiguated by fitting multiple single-touch profiles so the sum of the values of single-touch profiles nearly equals the multiple touch profile. This may be done by simultaneously adjusting multiple single-touch profiles to achieve a best match with the multiple touch profile, or by successively subtracting single-touch profiles from the multiple touch profile until, after all subtractions, the remaining residue values of the multi-touch profile are near zero.

Single-touch profiles may be derived by fitting a Gaussian curve to Width profiles, then rotating the curve 90° and applying the same profile to the Ridge values, using an assumption that measurements of a touch in width and length dimensions will have approximately the same profile. Or two or three points on one end of a set of Ridge values may be selected, then a Gaussian curve may be fitted to these points and extrapolated to encompass values of intermediate points, then the values of the fitted Gaussian curve may be subtracted from the multiple touch profile.

The algorithm is summarized below:
A. Fit a Gaussian curve to the Width of a Ridge at a selected point, (e.g. starting at the largest correlated value on the Ridge or at a correlated value at the end of the Ridge).
   a. Record the location in the Width direction (Offset of the Gaussian curve)
B. Rotate the Width-fitted curve 90° centered on the selected correlated value.
C. Fit the curve to Ridge values near the selected value, by adjusting only the offset (distance between electrode and the Mean) of the Gaussian curve.
D. Subtract the values of the curve from the corresponding Ridge values, (resulting in 0 value at the selected correlated value, and reduced adjacent values).
E. Select a next correlated value on the Ridge and repeat the Width curve fitting and subtraction process until all values on the former Ridge have been reduced to below-threshold residue values.
F. If residue values are large, offsets of curves in the Length direction may be re-adjusted to reduce residues. A recursive method may be used to adjust parameters (such as offsets) and test the effect on residues.

### Example Using Method 2 & 3

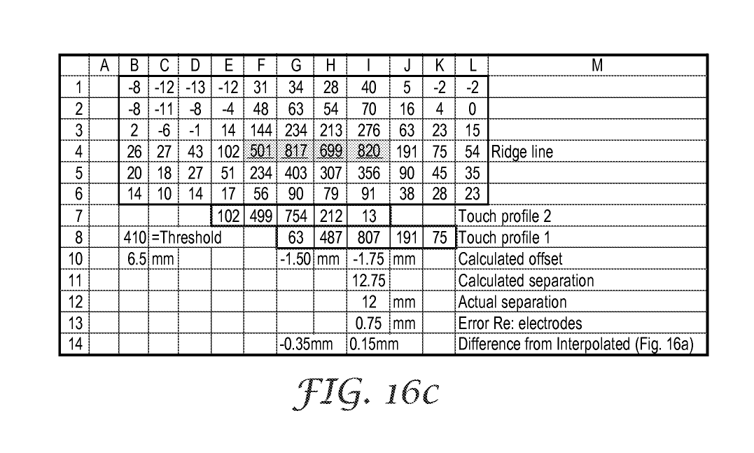

Tables shown in FIGS. 16a, 16b, and 16c show profiles and location calculations applied to two touches that are both approximately 9 mm in diameter. Touch centers are approximately 12 mm apart, measured on a sensor with electrodes spaced 6.5 mm center to center. Table 7a shows results of applying Method 2 whereby interpolation was used to apportion the intermediate value 699 based on the ratio of adjacent Ridge line values (817 and 820), and also to calculate interpolation ratios (in row 9), for offsets, (in row 10).

In the tables shown in FIG. 16b, Method 3 was used whereby two Gaussian curves were fitted to (vertical) Width vectors intersecting the two values 817 and 820. The curve through 817 had a standard deviation of 4.83 mm, and the curve through 820 had a standard deviation of 4.75. These curve shapes were rotated 90 degrees to align with the Ridge values, and the sum of the values of the two overlapping curves were compared to the measured values on the Ridge line. The means of the two curves were then independently adjusted to achieve a best fit with the Ridge line values. A least sum of squares error fit method was used. Offsets vs. the sensor electrodes were then calculated as the difference between the means of the Gaussian curves and the sensor electrodes that yielded the largest measured values.

In the table shown in FIG. 16c, Method 3 was also used whereby two Gaussian curves were fitted to the Ridge line of the measured data. The sum of values of two overlapping Gaussian curves were simultaneously compared to the measured values on the Ridge line, while the breadth (standard deviation) and the means of the two curves were adjusted to achieve a best fit with the Ridge line values. A least sum of squares error fit method was used. In this example, standard deviations of the two Gaussian curves were assumed to be equal.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the spirit and scope of this invention, and it should be understood that this invention is not limited to the illustrative embodiments set forth herein. For example, the reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A method of calculating one or more touch locations on a matrix capacitance touch measuring system comprising:
measuring touch-induced signals from multiple adjacent electrodes to provide measurement data;
combining measurement data to form a measured profile;
fitting the measured profile to at least one pre-determined profiles; and,
based on the fitting, calculating one or more touch locations associated with the touch-induced signals.

2. The method of claim 1, wherein the pre-determined profile includes at least one profile of multiple touches.

3. The method of claim 1, wherein the multiple adjacent electrodes are associated with a first dimension, and the touch location associated with the touch-induced signals is on the first dimension.

4. The method of claim 3, further comprising:
measuring touch-induced signals from a second set of multiple adjacent electrodes associated with a second dimension to provide further measurement data;
combining the further measurement data to form a further measured profile;
fitting the further measured profile to one of the pre-determined profiles; and,
based on the fitting of the further measured profile, calculating a touch location associated with the touch-induces signals on the second dimension.

5. A method of calculating touch locations from a matrix capacitance measuring system comprising:
storing a set of pre-determined profiles comprising measured or calculated values representative of touch-induced capacitance changes on a matrix capacitance measuring system, where at least one profile is consistent with a single touch and at least one profile is consistent with multiple touches in close proximity; and
combining measured signal changes from multiple adjacent electrodes in a first dimension to form a first measured profile and multiple adjacent electrodes in a second dimension to form a second measured profile; and,
selecting a first correlated profile from the set of pre-determined profiles that correlate with the first measured profile a second correlated profile from the set of pre-determined profiles that correlates with the second measured profile.

6. The method of claim 5, wherein the first set of profiles includes single-touch profiles and multiple-touch profiles.

7. A touch-sensitive apparatus comprising:
a panel comprising a touch surface and a plurality of electrodes defining an electrode matrix, the plurality of electrodes comprising a plurality of drive electrodes and a plurality of receive electrodes, each drive electrode being capacitively coupled to each receive electrode at a respective node of the matrix, the panel being configured such that a touch to the touch surface proximate to one of the nodes changes a coupling capacitance between the drive electrode and the receive electrode associated with the given node;
electronics configured to:
receive touch-induced measurement data as response signals associated with multiple adjacent receive electrodes;
combine the measurement data associated with the adjacent receive electrodes to form a measured profile;
fit the measured profile to at least one pre-determined profile; and,
based on the fitting, calculate one or more touch locations associated with the touch-induced signals.

8. The apparatus of claim 7, wherein two or more touch locations are fitted to a single profile.

9. An electronic device comprising a processor that receives touch-induced measurement data from a plurality of adjacent electrodes, and wherein the processor combines the measurement data from the plurality of adjacent electrodes to form a touch profile, then fits the touch profile to a pre-determined profile, and based on the fitting, calculates if the touch-induced measurement data is indicative of one or more than one touches.

10. The device of claim 9, wherein the pre-determined profile includes at least one profile of multiple touches.

11. The method of claim 1, wherein fitting is done by mathematical correlation.

12. The method of claim 1, wherein mathematical correlation is performed using one or more pre-determined profiles and the resulting correlation coefficient is used to determine touch locations.

13. The method of claim 1, wherein two or more touch locations are fitted to a single profile.

14. The method of claim 1, wherein at least one pre-determined profile is derived from calibration data.

15. The method of claim 4, wherein the first dimension is X, and the second dimension is Y.

16. The method of claim 15, further comprising:
providing location position information comprising the calculated X and Y dimensions to a computer.

17. The method of claim 5, further comprising:
calculating one or more touch locations based on the first and second correlated profiles.

18. The method of claim 17, further comprising:
providing signals indicative of the touch locations to a computer.

19. The apparatus of claim 7, wherein fitting comprises the use of mathematical correlation.

20. The apparatus of claim 7, wherein mathematical correlation is performed using one or more pre-determined profiles and the resulting correlation coefficient is used to determine touch locations.

21. The apparatus of claim 7, wherein the pre-determined profile includes at least one profile of multiple touches.

22. The apparatus of claim 7, wherein at least one pre-determined profile is derived from calibration data.

23. The apparatus of claim 7, wherein the multiple adjacent electrodes are associated with a first dimension, and the touch location associated with the touch-induced signals is on the first dimension.

24. The apparatus of claim 23, further comprising:
measuring touch-induced signals from a second set of multiple adjacent electrodes associated with a second dimension to provide further measurement data;
combining the further measurement data to form a further measured profile;
fitting the further measured profile to one of the pre-determined profiles; and,
based on the fitting of the further measured profile, calculating a touch location associated with the touch-induces signals on the second dimension.

25. The apparatus of claim 24, wherein the first dimension is X, and the second dimension is Y.

26. The apparatus of claim 25, further comprising:
providing location position information comprising the calculated X and Y dimensions to a computer.

27. The device of claim 9, wherein the processor further calculates the locations of the touches associated with the measurement data.

28. The device of claim 9, wherein the fitting is done using mathematical correlation techniques.
